(19) United States
(12) Patent Application Publication
(10) Pub. No.: US 2026/0106818 A1
(43) Pub. Date: Apr. 16, 2026

(54) Packet Transmission with Implicit Loss Indication (ILI)

(71) Applicant: Mellanox Technologies, Ltd., Yokneam (IL)

(72) Inventors: Ariel Shahar, Jerusalem (IL); Yamin Friedman, Jerusalem (IL); Tzur Raanan, Yokneam Ilit (IL); Kfir Assor, Haifa (IL)

(21) Appl. No.: 18/915,400

(22) Filed: Oct. 15, 2024

(51) Int. Cl. H04L 43/0829

(52) U.S. Cl. CPC H04L 43/0829

(57) ABSTRACT

A network device includes a port and packet processing circuitry. The port is to connect to a network. The packet processing circuitry is to transmit a data packet to the network, and, after transmitting the data packet, transmit to the network an Implicit Loss Indication (ILI) packet that (i) references the data packet and (ii) is provisioned to traverse a same route via the network as the data packet.

### TECHNICAL FIELD

The present disclosure relates generally to packet communication, and particularly to methods and systems for loss indication in network devices.

### BACKGROUND

Some packet communication networks are lossy by design. In a lossy network, network devices will occasionally drop packets. Packet drops may occur, for example, when a buffer or queue becomes full or when the required bandwidth on a link or port exceeds the available bandwidth. Lossy network protocols typically include retransmission mechanisms in which a destination network device detects missing packets and requests a source network device to retransmit them.

### SUMMARY

An embodiment that is described herein provides a network device including a port and packet processing circuitry. The port is to connect to a network. The packet processing circuitry is to transmit a data packet to the network, and, after transmitting the data packet, transmit to the network an Implicit Loss Indication (ILI) packet that (i) references the data packet and (ii) is provisioned to traverse a same route via the network as the data packet.

Typically, the ILI packet is smaller than the data packet. In some embodiments, the packet processing circuitry is to assign the ILI packet a Layer-2 (L2) header and a Layer-3 (L3) header that match the L2 header and the L3 header of the data packet. In some embodiments, the packet processing circuitry is to assign the ILI packet a Base Transport Header (BTH) that refers to a BTH of the data packet. In some embodiments, the ILI packet references the data packet by indicating a Packet Serial Number (PSN) of the data packet.

In an embodiment, the packet processing circuitry is to transmit to the network at least one additional ILI packet that references the data packet and is provisioned to traverse the same route via the network as the data packet. In an embodiment, the ILI packet references both the data packet and one or more other data packets.

There is additionally provided, in accordance with an embodiment that is described herein, a network device including a port and packet processing circuitry. The port is to connect to a network. The packet processing circuitry is to receive from the network an Implicit Loss Indication (ILI) packet that references a data packet, to check whether the data packet referenced by the ILI packet was received before the ILI packet, and, in response to finding that the data packet referenced by the ILI packet was not received before the ILI packet, to request retransmission of the data packet.

In some embodiments, the packet processing circuitry is to discard the ILI packet in response to finding that the data packet referenced by the ILI packet was received. In some embodiments, the packet processing circuitry is to request the retransmission by sending a negative acknowledgement (NACK). In an embodiment, the ILI packet references both the data packet and one or more other data packets. In an embodiment, the packet processing circuitry is to exclude the ILI packet from at least one authentication check applied to data packets.

There is additionally provided, in accordance with an embodiment that is described herein, a method including transmitting a data packet to the network. After transmitting the data packet, an Implicit Loss Indication (ILI) packet is transmitted to the network. The ILI packet (i) references the data packet and (ii) is provisioned to traverse a same route via the network as the data packet.

There is also provided, in accordance with an embodiment that is described herein, a method including receiving from the network an Implicit Loss Indication (ILI) packet that references a data packet. A check is performed whether the data packet referenced by the ILI packet was received before the ILI packet. In response to finding that the data packet referenced by the ILI packet was not received before the ILI packet, retransmission of the data packet is requested.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a packet communication system using Implicit Loss Indication (ILI) packets, in accordance with an embodiment that is described herein;

FIG. 2 is a flow chart that schematically illustrates a method for packet communication using ILI packets, in accordance with an embodiment that is described herein; and

FIG. 3 is a block diagram that schematically illustrates a computing system comprising network devices that use ILI packets, in accordance with an embodiment that is described herein.

### DETAILED DESCRIPTION OF EMBODIMENTS

### OVERVIEW

Packet retransmission mechanisms are problematic since they incur excessive latency and complexity. The latency incurred by retransmission includes, among others, the time needed for the destination network device to detect that a packet was lost, and the Round-Trip Time (RTT) needed for the destination network device to request retransmission and for the source network device to retransmit the lost packet. Detecting a lost packet is especially slow and difficult when the network does not guarantee in-order delivery of packets from the source network device to the destination network device, as the arrival of packet following a missing packet, does not necessarily imply that the missing packet is lost.

Embodiments that are described herein provide improved techniques that enable a network device to detect loss of packets simply, quickly and reliably.

In some embodiments, after transmitting a data packet, the source network device transmits an additional packet referred to herein as an Implicit Loss Indication (ILI) packet. The ILI packet (i) references the data packet and (ii) is provisioned to travel the same route via the network as the data packet. For example, the ILI packet may be generated with the same Layer-2 (L2) and Layer-3 (L3) headers as the data packet, ensuring that network elements will forward the data packet and the ILI packet over the same route. To minimize bandwidth overhead, the ILI packet is typically much smaller than the data packet it references.

Since the ILI packet is transmitted after the data packet and traverses the same route, it will typically arrive after the data packet even if the network does not guarantee in-order packet delivery. Therefore, if the destination network device receives an ILI packet that was not preceded by a corresponding data packet, it can immediately conclude that the data packet has been lost.

Thus, in some embodiments, upon receiving an ILI packet, the destination network device checks whether the data packet referenced by the ILI packet was already received. If so, the destination network device may discard the ILI packet. If the data packet was not received before the ILI packet, the destination network device immediately requests the source network device to retransmit the data packet in question.

The disclosed technique is simple to implement and provides fast and reliable detection of lost packets. Although the transmission of ILI packets incurs some inevitable bandwidth overhead, this penalty is small due to the small size of the ILI packets, and is typically well worth the gain in packet-loss detection performance. The disclosed technique can be used with any lossy network protocol. The embodiments described herein refer mainly to Remote Direct Memory Access (RDMA) networks, in which case the source network device is referred to as a “requestor” and the destination network device is referred to as a “responder”.

### SYSTEM DESCRIPTION

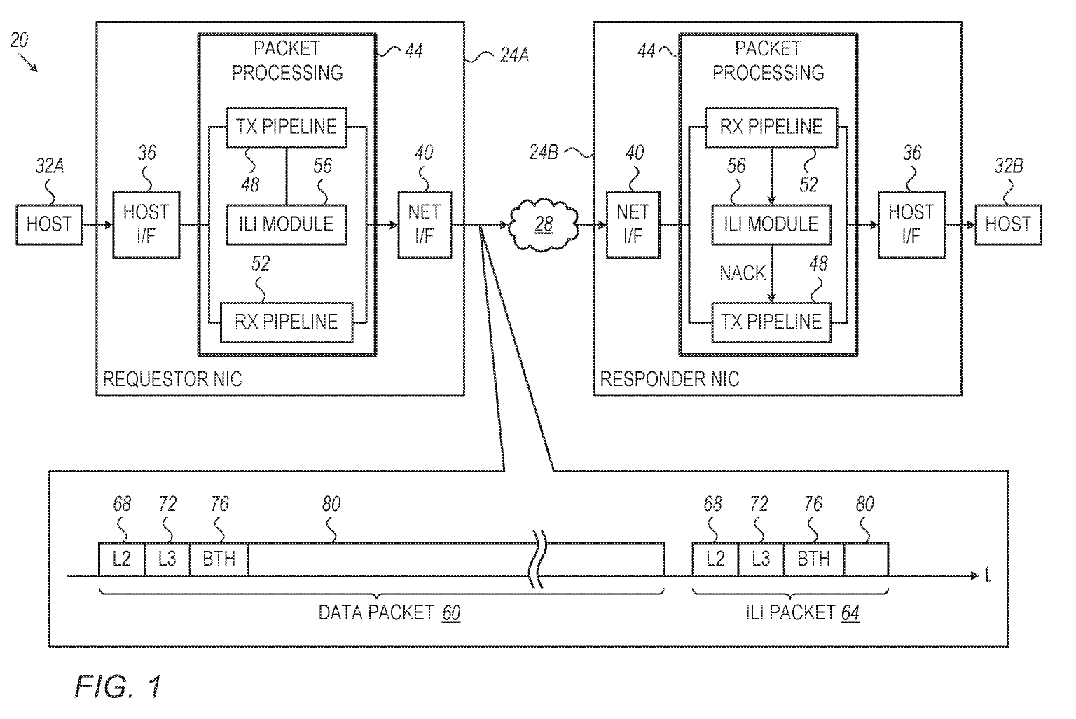

FIG. 1 is a block diagram that schematically illustrates a packet communication system 20 using Implicit Loss Indication (ILI) packets, in accordance with an embodiment that is described herein. System 20 comprises a requestor Network Interface Controller (NIC) 24A and a responder NIC 24B that communicate over a network 28. NIC 24A serves a host 32A, and NIC 24B serves a host 32B. Hosts 32A and 32B may comprise, for example, Central Processing Units (CPUs), Graphics Processing Units (GPUs) or any other suitable computing platform.

In the present example, network 28 is an Ethernet network and NICs 24A and 24B communicate in accordance with the RDMA protocol. Generally, however, requestor NIC 24A and responder NIC 24B are regarded herein as non-limiting examples of a source network device and a destination network device, respectively. In alternative embodiments, the network devices may comprise, for example, Data Processing Units (DPUs, also referred to as “smart NICs”).

Typically, NICs 24A and 24B are similar or identical in design, and their roles as “requestor” and “responder” apply to a specific RDMA transaction. Each of the NICs may serve as a requestor for some transactions, and as a responder for other transactions.

The disclosed techniques can also be used in various other suitable types of networks. Network 28 is typically a lossy network, and does not necessarily guarantee in-order delivery of packets between NICs 24A and 24B. For example, network 28 may employ multipathing techniques in which the packets sent from NIC 24A to NIC 24B are distributed across multiple different routes that may differ in latency.

Each of NICs 24A and 24B comprises a host interface 36 for communicating with its respective host (32A or 32B), a network interface 40 for communicating over network 28, and packet processing circuitry 44 for performing the various processing tasks of the NIC. Host interfaces 36 may communicate with the hosts using any suitable interface or protocol, e.g., over a peripheral bus such as Peripheral Component Interconnect express (PCIe) or Nvlink. Alternatively, host interfaces 36 may comprise Chip-to-Chip (C2C) or Die-to-Die (D2D) links such as Ground Reference Signaling (GRS), Low Power Interface (LPI) or Low Latency Interface (LLI). Network interfaces 40 are also referred to as the ports of the respective network devices.

Packet processing circuitry 44 comprises a transmit (TX) pipeline 48, a receive (RX) pipeline 52, and an ILI module 56. TX pipeline 48 generates and processes outbound packets, i.e., packets transmitted to network 28. RX pipeline 52 processes inbound packets, i.e., packets received from network 28. ILI module 56 carries out the processing relating to ILI packets, as described in detail below.

The configuration of system 20 and NICs 24A and 24B, as illustrated in FIG. 1, are example configurations chosen purely for the sake of conceptual clarity. In alternative embodiments, any other suitable configuration can be used.

For example, the network device that generates the ILI packet need not necessarily be the network device serving the source host. By the same token, the network device that detects loss of the data packet using the ILI packet, and requests retransmission, need not necessarily be the network device serving the destination host. In other words, the disclosed technique can be used between intermediate network devices, e.g., network switches or routers, within network 28.

NICs 24A and 24B may be implemented using suitable hardware, such as in one or more Application-Specific Integrated Circuits (ASICs) or Field-Programmable Gate Arrays (FPGAs), using software, using hardware, or using a combination of hardware and software elements. Elements that are not mandatory for understanding of the disclosed techniques have been omitted from the figure for the sake of clarity.

In some embodiments, some NIC functions described herein may be implemented in a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### PACKET LOSS DETECTION USING ILI PACKETS

Referring again to FIG. 1, an inset at the bottom of the figure illustrates a data packet 60 and a corresponding ILI packet 64. Both packets are transmitted from requestor NIC 24A via network 28 to responder NIC 24B. ILI packet 64 is transmitted after (typically immediately after) data packet 60, to enable responder NIC 24B to detect whether data packet 60 was lost.

In some embodiments, data packet 60 and ILI packet 64 each comprises a Layer-2 (L2) header 68, a Layer-3 (L3) header 72, a Base Transport Header (BTH) 76, and a payload 80. L2 header 68 may comprise, for example, a Medium Access Control (MAC) header. L3 header 72 may comprise, for example, an Internet Protocol (IP) header.

In the present example, ILI packet 64 is considerably smaller than data packet 60, e.g., due to the much smaller size of payload 80. The small size of ILI packet 64 serves two purposes — (i) reducing the extra bandwidth consumed by the ILI packet, and (ii) reducing the likelihood that the ILI packet itself will be dropped. In an example embodiment, the size of data packet 60 is 4Kbytes, whereas the size of ILI packet 64 is sixty-four bytes. Alternatively, any other suitable packet sizes can be used.

In some embodiments, L2 header 68 of ILI packet 64 is identical to L2 header 68 of data packet 60; and L3 header 72 of ILI packet 64 is identical to L3 header 72 of data packet 60. This condition ensures that the network switches or routers of network 28 will forward data packet 60 and ILI packet 64 over the same route. More generally, any other header field values, which ensure that data packet 60 and ILI packet 64 will travel the same route, can be used.

ILI packet 64 references data packet 60. In the present context, the term “references” means that the ILI packet comprises information that enables NIC 24B to determine uniquely the identity of the corresponding data packet. In an example embodiment, data packet 60 comprises a Packet Serial Number (PSN). The PSN may be specified, for example, in BTH 76 of the data packet. ILI packet 64 may reference data packet 60 by specifying the PSN of data packet 60, e.g., as part of BTH 76 of the ILI packet. In alternative embodiments, ILI packet 64 may reference data packet 60 in any other suitable way.

In some embodiments, ILI packet 64 has a unique opcode that identifies it as an ILI packet.

In some embodiments, data packet 60 comprises a Cyclic Redundancy Check (CRC) (e.g., an Invariant Cyclic Redundancy Check—ICRC—used in InfiniBand) that is calculated over at least some of the packet for detecting errors. In one embodiment, ILI module 56 of requestor NIC 24A recalculates the CRC over at least part of ILI packet 64, and inserts the recalculated CRC into the ILI packet. In this embodiment, responder NIC 24B may validate the CRC of the receive ILI packet to ensure it is correct. In an alternative embodiment, ILI module 56 of requestor NIC 24A does not recalculates the CRC for ILI packet 64 (e.g., requestor NIC 24A may simply reuse the CRC of data packet 60). In this embodiment, the ILI packet will not have a CRC that matches its content, but this may be tolerable since the ILI packet is not an actual data packet. When using the latter embodiment, responder NIC 24B should refrain from validating the CRCs received ILI packets.

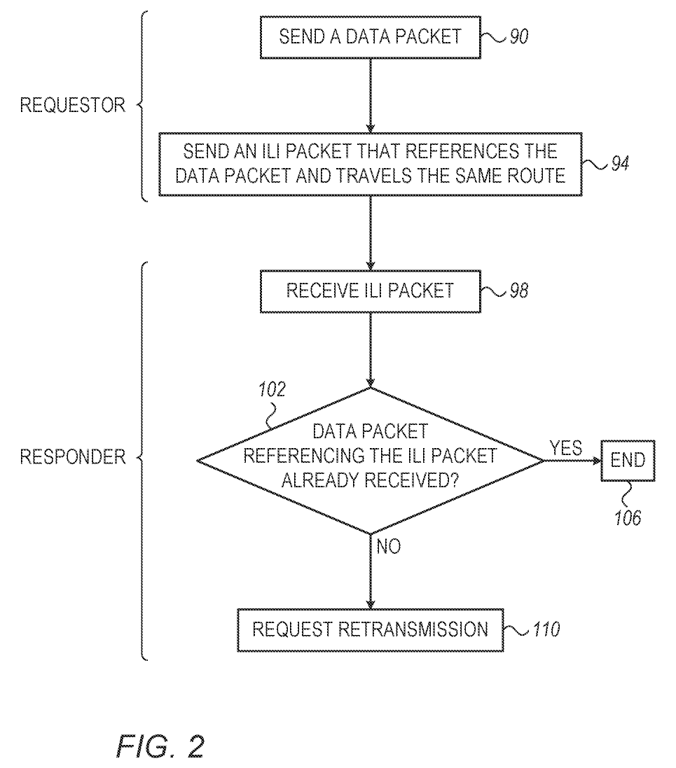

FIG. 2 is a flow chart that schematically illustrates a method for packet communication using ILI packets, in accordance with an embodiment that is described herein. The method begins with TX pipeline 48 of requestor NIC 24A sending a data packet to responder NIC 24B, at a data packet transmission stage 90. Following the data packet, TX pipeline 48 of requestor NIC 24A sends an ILI packet to responder NIC 24B, at an ILI packet transmission stage 94. In the configuration of FIG. 1, the ILI packet is generated by ILI module 56 and provided to TX pipeline 48 for transmission. As explained above, ILI module 56 generates the ILI packet so as to (i) reference the data packet, and (ii) travel the same route as the data packet.

At an ILI packet reception stage 98, responder NIC 24B receives the ILI packet. (This stage may or may not be preceded by reception of the data packet.) At a checking stage 102, ILI module 56 of responder NIC 24B checks whether the data packet referenced by the ILI packet was already received. If so, ILI module 56 discards the ILI packet and the method terminates, at a termination stage 106.

Otherwise, i.e., if ILI module 56 of responder NIC 24B finds that the referenced data packet was not received before the ILI packet, ILI module initiates a retransmission request, at a retransmission requesting stage 110. The retransmission request may have any suitable format that indicates the identity of the lost data packet to requestor NIC 24A.

In an example embodiment, the retransmission request is a NACK packet indicating the PSN of the lost data packet. In an example embodiment, the retransmission request comprises a bitmap that references a block of packets and indicates which packets in the block were lost and need to be retransmitted. This sort of retransmission request is sometimes referred to as “block ACK” or “block NACK”. Alternatively, any other suitable type of retransmission request can be used. In an embodiment, ILI module 56 provides the retransmission request to TX pipeline 48 of responder NIC 24B for transmission. TX pipeline 48 sends the retransmission request to network 28, addressed to requestor NIC 32A.

The method flow of FIG. 2 is an example flow that is depicted purely for the sake of conceptual clarity. Alternatively, the disclosed techniques can be implemented using any other suitable flow.

For example, in some embodiments, packet processing circuitry 44 of requestor NIC 24A generates two or more ILI packets that reference the same data packet. This feature increases the likelihood that at least one of the ILI packets will reach responder NIC 24B, at the cost of some additional bandwidth and packet generation overhead.

As another example, in some embodiments, packet processing circuitry 44 of requestor NIC 24A generates a single ILI packet that references two or more data packets (and transmits the ILI packet after all the referenced data packets). Upon receiving this ILI packet, responder NIC 24B checks which of the referenced data packets were previously received. If any of the referenced data packets did not arrive before the ILI packet, NIC 24B may decide that the data packet was lost and request retransmission.

As yet another example, in some embodiments, packet processing circuitry 44 of requestor NIC 24A generates ILI packets selectively, only for certain data packets. For example, when a certain message is conveyed by multiple data packets, ILI packets may be generated only for one or more data packets that carry the end of the message, so as to protect against "tail drops". Generally, packet processing circuitry 44 of requestor NIC 24A may use any other suitable criterion for selecting which data packets to protect using ILI packets.

In some embodiments, packet processing circuitry 44 of responder NIC 24B performs certain authentication checks on received data packets before processing them and/or before forwarding their data to host 32B. In an embodiment, packet processing circuitry 44 of responder NIC 24B excludes ILI packets from one or more of these authentication checks, e.g., an ICRC check. The protocol can be defined to selectively check or refrain from checking the ICRC.

### EXAMPLE SYSTEM USE-CASE

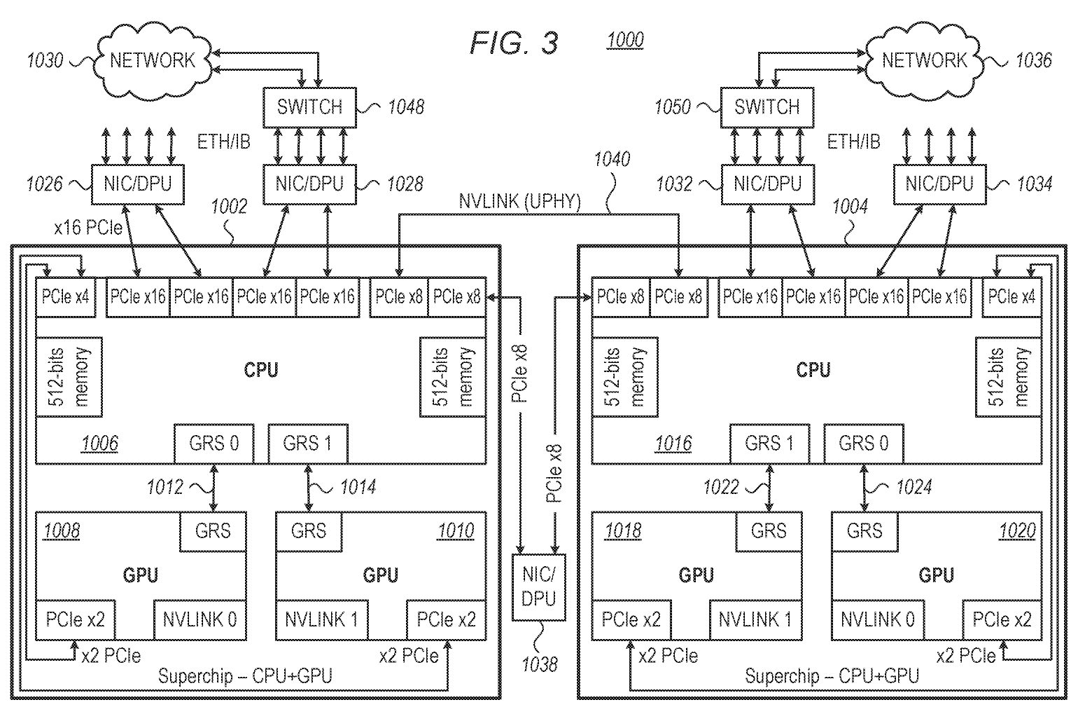

FIG. 3 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 3 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 3, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 3, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

In various embodiments, any of the network devices of system 1000, e.g., any of NICs/DPUs 1026, 1028, 1032, 1034 and 1038, and/or any of switches 1048 and 1050, may use ILI packets in accordance with the techniques described herein. The packet switches in FIG. 3 may comprise, for example, Nvidia Quantum-2 switches. The NICs/DPUs in the figure may comprise, for example, Nvidia Bluefield DPUs.

Although the embodiments described herein mainly address lossy network protocols, the methods and systems described herein can also be used in lossless protocols in which packets may still be dropped, for example due to bit-flipping. Further alternatively, the disclosed techniques can be used in any other suitable application.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network device, comprising:
a port, to connect to a network; and
packet processing circuitry, to:
transmit a data packet to the network; and
after transmitting the data packet, transmit to the network an Implicit Loss Indication (ILI) packet that (i) references the data packet and (ii) is provisioned to traverse a same route via the network as the data packet.

2. The network device according to claim 1, wherein the ILI packet is smaller than the data packet.

3. The network device according to claim 1, wherein the packet processing circuitry is to assign the ILI packet a Layer-2 (L2) header and a Layer-3 (L3) header that match the L2 header and the L3 header of the data packet.

4. The network device according to claim 1, wherein the packet processing circuitry is to assign the ILI packet a Base Transport Header (BTH) that refers to a BTH of the data packet.

5. The network device according to claim 1, wherein the ILI packet references the data packet by indicating a Packet Serial Number (PSN) of the data packet.

6. The network device according to claim 1, wherein the packet processing circuitry is to transmit to the network at least one additional ILI packet that references the data packet and is provisioned to traverse the same route via the network as the data packet.

7. The network device according to claim 1, wherein the ILI packet references both the data packet and one or more other data packets.

8. A network device, comprising:
a port, to connect to a network; and
packet processing circuitry, to:
receive from the network an Implicit Loss Indication (ILI) packet that references a data packet;
check whether the data packet referenced by the ILI packet was received before the ILI packet; and
in response to finding that the data packet referenced by the ILI packet was not received before the ILI packet, request retransmission of the data packet.

9. The network device according to claim 8, wherein the packet processing circuitry is to discard the ILI packet in response to finding that the data packet referenced by the ILI packet was received.

10. The network device according to claim 8, wherein the packet processing circuitry is to request the retransmission by sending a negative acknowledgement (NACK).

11. The network device according to claim 8, wherein the ILI packet references both the data packet and one or more other data packets.

12. The network device according to claim 8, wherein the packet processing circuitry is to exclude the ILI packet from at least one authentication check applied to data packets.

13. A method, comprising:
transmitting a data packet to the network; and
after transmitting the data packet, transmitting to the network an Implicit Loss Indication (ILI) packet that (i) references the data packet and (ii) is provisioned to traverse a same route via the network as the data packet.

14. The method according to claim 13, wherein the ILI packet is smaller than the data packet.

15. The method according to claim 13, further comprising transmitting to the network at least one additional ILI packet that references the data packet and is provisioned to traverse the same route via the network as the data packet.

16. The method according to claim 13, wherein the ILI packet references both the data packet and one or more other data packets.

17. A method, comprising:
receiving from the network an Implicit Loss Indication (ILI) packet that references a data packet;
checking whether the data packet referenced by the ILI packet was received before the ILI packet; and
in response to finding that the data packet referenced by the ILI packet was not received before the ILI packet, requesting retransmission of the data packet.

18. The method according to claim 17, and comprising discarding the ILI packet in response to finding that the data packet referenced by the ILI packet was received.

19. The method according to claim 17, wherein requesting the retransmission comprises sending a negative acknowledgement (NACK).

20. The method according to claim 17, and comprising excluding the ILI packet from at least one authentication check applied to data packets.
